(19) United States
(12) Patent Application Publication
(10) Pub. No.: US 2010/0261359 A1
(43) Pub. Date: Oct. 14, 2010

(54) EMI SHIELD SPRING DEVICE

(75) Inventors: MING-CHIH CHAN, Tu-Cheng (TW); XIAO-QIN JIANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/752,127

(22) Filed: Apr. 1, 2010

(30) Foreign Application Priority Data
Apr. 10, 2009 (CN) 200920302056.7

(51) Int. Cl. H01R 12/00

(52) U.S. Cl. 439/81

(57) ABSTRACT

An electro-magnetic interference device attached to a surface of an object by soldering is disclosed. The device comprises a base comprising a surface defining at least one recessed portion. The at least one recessed portion comprises a side wall. An angle between the side wall and the surface of the base is equal to or greater than 90 degrees.

### BACKGROUND

1. Technical Field

The present disclosure relates to an electro-magnetic interference (EMI) shield spring device.

2. Description of Related Art

EMI shield spring clips/contacts are known in the art, such as the EMI shield springs described in U.S. Pat. No. 5,532,428 to Radloff et al., U.S. Pat. No. 6,678,170 to Barringer et al., and U.S. Pat. No. 5,225,269 to Garrett. The EMI shield spring clips/contacts can be attached to a circuit board of an electronic device by soldering. However, in certain instances, for example, when the circuit board is small and includes large quantity of electrical components, leaves a small area for contacting and welding the EMI shield springs. As such, EMI shield spring may have a weak connection with the circuit board and tends to disengage.

What is needed is an EMI shield spring device to solve the aforementioned problems.

### BRIEF DESCRIPTION OF THE DRAWINGS

The components in the drawings are not necessarily drawn to scale, the emphasis instead being placed upon clearly illustrating the principles of the EMI shield spring device. Moreover, in the drawings, like reference numerals designate corresponding parts throughout the several views.

FIG. 1 is an isometric view of a detachable portable shielding device in accordance with an exemplary embodiment.

FIG. 2 is an isometric view of the shielding device in FIG. 1 from a different angle.

FIG. 3 is a cross-sectional view of a connecting surface of the shielding device in FIG. 1, in accordance with a first exemplary embodiment.

FIG. 4 is another cross-sectional view of the connecting surface of the shielding device in FIG. 1, in accordance with a second exemplary embodiment.

### DETAILED DESCRIPTION

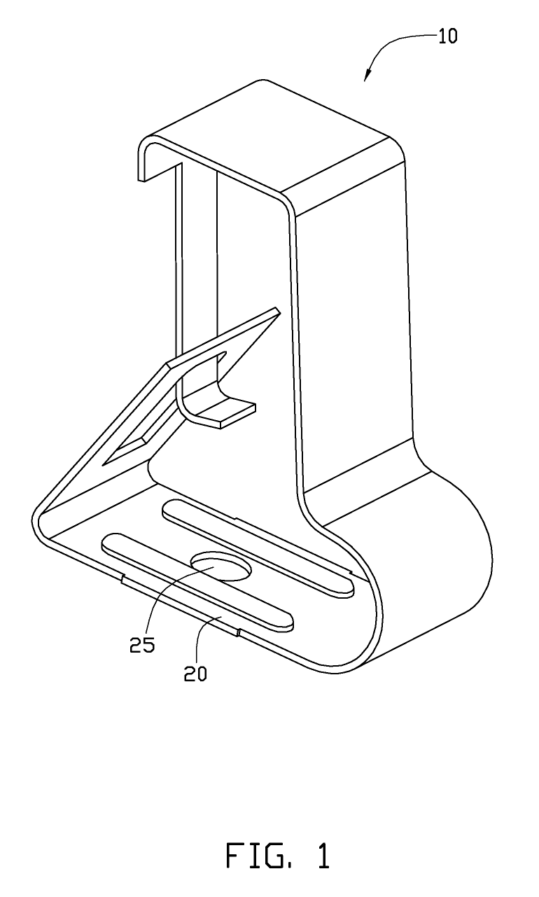

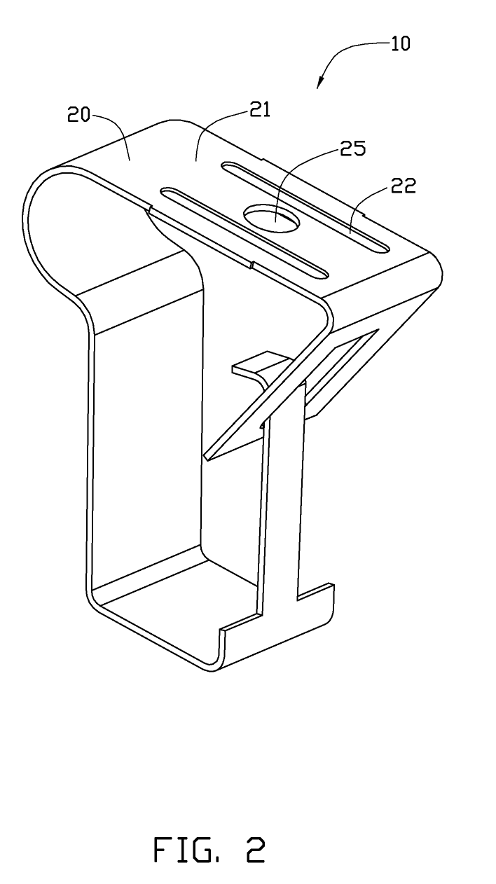

Referring to FIGS. 1 and 2, a device 10 to be attached to a surface of an object is disclosed in accordance with an exemplary embodiment. In the exemplary embodiment, the device 10 is an electro-magnetic interference (EMI) shield spring clip/contact. The spring clip/contact 10 includes a rectangular base plate 20. In the embodiment, the base plate 20 is made of metallic material and includes a soldering surface 21 defining two recessed portions 22 formed by stamping. The soldering surface 21 is a planar surface.

In the exemplary embodiment, the recessed portions 22 are formed by stamping. The recessed portions 22 extend along the lengthwise direction of the base plate 20. The recessed portions 22 are parallel to each other. The geometry shape of the recessed portions is not limited and may be modified according to need. One aspect influencing the geometry shape and other parameters such as depth is the height of the spring clip/contact 10.

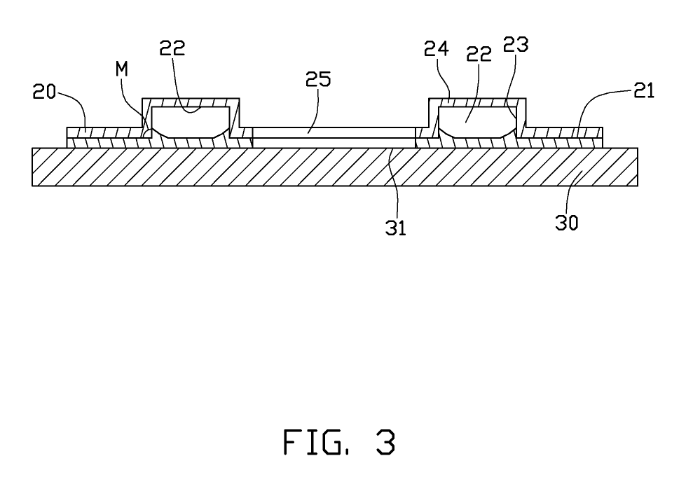

Referring to FIG. 3, the recessed portion 22 includes two sidewalls 23 opposite to each other and a top wall 24 connecting the sidewalls 23. In the exemplary embodiment, an angle M between the side wall 23 and the soldering surface 21 is about 90 degrees.

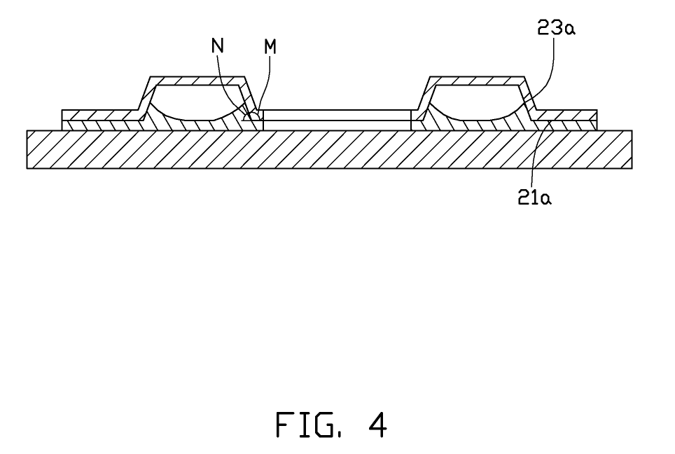

In another embodiment shown in FIG. 4, the sidewall 23a is angled from the soldering surface 21a. An angle M between the side wall 23a and the soldering surface 21a is greater than 90 degrees. In the embodiment, the angle M is about 135 degrees.

The spring clip/contact 10 can be soldered to the object, such as a circuit board 30 by surface mounting techniques. After the spring clip/contact 10 is soldered to the circuit board 30, a layer of solder is formed between the surface 31 and a surface of the circuit board 30. A certain quantity of solder forms within the recessed portions 22. That is, in addition to the surface 21, the side walls 23 also connect to the surface 31 by solder, which assists to increase the connection strength between the spring clip/contact 10 and the circuit board 30.

It is noteworthy, that the wettability of the surface 31 is important. This gives adhesion and cohesion that result in strong interfacial tension. The smaller the wetting angle of a surface, the greater the wettability of its surface by a specific liquid and vice versa.

Because the angle M is equal to or greater than 90 degrees, the wetting angle or contact angle N, which measured between the side wall 23 and the imaginary line L, is a supplementary angle of the angle M and is equal to or less than 90 degrees. With such structure of the recessed portions 22, the mechanical connection between the spring clip/contact 10 and the circuit board 30 becomes stronger than it otherwise would be.

In the exemplary embodiment, to facilitate the wetting of the surface 31, a through opening 25 is formed between the recessed portions 22. In another embodiment, the top wall 24 may be removed, so that the recessed portions 22 extend through the base plate 20, which assists the wetting of the surface 31.

When the spring clip/contact 10 is shaped to have a dimension of 6.3 mm (length) by 5.5 mm (width) by 2.5 mm (height) by 0.1 mm (thickness), and the recessed portion 22 is shaped to be 2.3 mm (length) by 0.2 mm (width) by 0.15 mm (depth), the connection strength between the spring clip/contact 10 and the circuit board 30 increases by 126%. Comparing to when the spring clip/contact 10 has no such recessed portion.

While various embodiments have been illustrated and described, the disclosure is not to be construed as being limited thereto. Those skilled in the art can make various modifications to the embodiments without departing from the true spirit and scope of the disclosure as defined by the appended claims.

What is claimed is:

1. An electro-magnetic interference (EMI) device for being attached to a surface of an object by soldering, the device comprising:
a base comprising a surface defining at least one recessed portion, the at least one recessed portion comprising a side wall, wherein, an angle between the side wall and the surface of the base is equal to or greater than 90 degrees.

2. The EMI device according to claim 1, wherein the device is shaped as a spring.

3. The EMI device according to claim 1, wherein the number of the at least one recessed portion is two.

4. The EMI device according to claim 1, wherein the surface of the base defines a through opening.

5. The EMI device according to claim 3, wherein the surface of the base defines a through opening, the through opening is formed between the two recessed portions.

6. The EMI device according to claim 1, wherein the surface of the base is planar.

7. The EMI device according to claim 1, wherein the device is made of metallic material and the at least one recessed portion is formed by stamping.

8. The EMI device according to claim 7, wherein the at least one recessed portion extends through the base.

9. The EMI device according to claim 1, wherein the at least one recessed portion extends along the lengthwise direction of the base.

10. The EMI device according to claim 1, wherein each of the at least one recessed portion is elongated with a length of about 2.3 millimeter and a width of about 0.2 millimeter.
